(19) United States
(12) Patent Application Publication
(10) Pub. No.: US 2020/0138259 A1
(43) Pub. Date: May 7, 2020

(54) WATER CONSUMPTION ACQUISITION METHOD OF CLEANING ROBOT AND DEVICE THEREOF

(71) Applicants: JIANGSU MIDEA CLEANING APPLIANCES CO., LTD., Suzhou (CN); MIDEA GROUP CO., LTD., Foshan (CN)

(72) Inventors: Xiaoming XU, Suzhou (CN); Ke LI, Suzhou (CN); Fangming JIN, Suzhou (CN); Jiuxiang LI, Suzhou (CN); Tailong JIN, Suzhou (CN); Chun LUAN, Suzhou (CN)

(21) Appl. No.: 16/673,960

(22) Filed: Nov. 5, 2019

(30) Foreign Application Priority Data
Nov. 5, 2018 (CN) 201811305956.7

(51) Int. Cl. A47L 9/28; B25J 11/00; B25J 9/16

(52) U.S. Cl. CPC A47L 9/2826; A47L 9/2847; A47L 2201/06; B25J 9/1697; B25J 11/0085

(57) ABSTRACT

Provided are method and apparatus for acquiring water consumption of a robot vacuum cleaner, an electronic device and a non-transitory computer readable storage medium. Further, the method for acquiring water consumption of the robot vacuum cleaner includes: controlling the robot vacuum cleaner to acquire an image of ground to be cleaned, and acquiring the image of the ground to be cleaned; controlling the robot vacuum cleaner to detect a humidity of the ground to be cleaned, and acquiring humidity information of the ground to be cleaned; acquiring a target water consumption of the robot vacuum cleaner according to the image of the ground and the humidity information; and controlling the robot vacuum cleaner to clean the ground to be cleaned according to the target water consumption.

### CROSS-REFERENCES TO RELATED APPLICATIONS

The present application is based on and claims priority to Chinese patent application number 201811305956.7, filed on Nov. 5, 2018, the entire disclosure of which is hereby incorporated by reference.

### FIELD

The present disclosure relates to a field of smart home appliance technology, and particular to method and apparatus for acquiring water consumption of a robot vacuum cleaner, an electronic device and a non-transitory computer readable storage medium.

### BACKGROUND

For an existing robot vacuum cleaner which is able to sweep and mop the ground, water consumption is fixed and cannot be adjusted according to actual conditions when the cleaner is working, where cleaning effect may be negatively affected. Over large water consumption may even affect the ground of some materials and damage the ground.

### SUMMARY

The present disclosure seeks to solve at least one of the problems that exist in the related art to at least some extent.

One embodiment of the present disclosure is to provide a method for acquiring water consumption of a robot vacuum cleaner. With such a method, a current situation of a target to be cleaned may be detected by intelligent means, and an optimal water quantity parameter can be recommended according to the current situation, so as to realize the control of the water consumption adapted to the target to be cleaned and achieve an optimal water discharge effect, thus improving intelligence level and cleaning efficiency of the robot vacuum cleaner.

Another embodiment of the present disclosure is to provide an apparatus for acquiring water consumption of a robot vacuum cleaner.

Still another embodiment of the present disclosure is to provide an electronic device.

A further embodiment of the present disclosure is to provide a non-transitory computer readable storage medium.

One embodiment of the present disclosure provides in embodiments a method for acquiring water consumption of a robot vacuum cleaner, including:

controlling the robot vacuum cleaner to acquire an image of ground to be cleaned, thereby acquiring the image of the ground to be cleaned;

controlling the robot vacuum cleaner to detect a humidity of the ground to be cleaned, thereby acquiring humidity information of the ground to be cleaned;

acquiring a target water consumption of the robot vacuum cleaner according to the image of the ground and the humidity information; and

controlling the robot vacuum cleaner to clean the ground to be cleaned according to the target water consumption.

Another embodiment of the present disclosure provides in embodiments an apparatus for acquiring water consumption of a robot vacuum cleaner, including:

an image acquiring device configured to control the robot vacuum cleaner to acquire an image of ground to be cleaned, so as to acquire the image of the ground to be cleaned;

a humidity acquiring device configured to control the robot vacuum cleaner to detect a humidity of the ground to be cleaned, so as to acquire humidity information of the ground to be cleaned;

a water consumption acquiring device configured to acquire a target water consumption of the robot vacuum cleaner according to the image of the ground and the humidity information; and

a cleaning control device configured to control the robot vacuum cleaner to clean the ground to be cleaned according to the target water consumption.

With such an apparatus for acquiring water consumption of the robot vacuum cleaner provided in embodiments of the present disclosure, a current situation of a target to be cleaned may be detected by intelligent means, and an optimal water quantity parameter can be recommended according to the current situation, so as to realize the control of the water consumption adapted to the target to be cleaned and achieve an optimal water discharge effect, thus improving intelligence level and cleaning efficiency of the robot vacuum cleaner.

One embodiment of the present disclosure provides in embodiments an electronic device, including: a memory, a processor; in which the processor reads an executable program code stored in the memory to execute a program corresponding to the executable program code, so as to perform a method for acquiring water consumption of a robot vacuum cleaner provided in the embodiments of the present disclosure.

Another embodiment of the present disclosure provides in embodiments a non-transitory computer readable storage medium having stored therein a computer program that, when executed by a processor, causes the processor to perform a method for acquiring water consumption of a robot vacuum cleaner provided in the embodiments of the present disclosure.

Embodiments of present disclosure will be given in part in the following descriptions, become apparent in part from the following descriptions, or be learned from the practice of the embodiments of the present disclosure.

### BRIEF DESCRIPTION OF THE DRAWINGS

Embodiments of the present disclosure will become apparent and more readily appreciated from the following descriptions made with reference to the drawings, in which:

FIG. 1 is a flow chart of a method for acquiring water consumption of a robot vacuum cleaner according to an embodiment of the present disclosure;

FIG. 2 is a flow chart of a method for acquiring water consumption of a robot vacuum cleaner according to another embodiment of the present disclosure;

FIG. 3 is a flow chart of a method for acquiring water consumption of a robot vacuum cleaner according to still another embodiment of the present disclosure;

FIG. 4 is a schematic diagram of an apparatus for acquiring water consumption of a robot vacuum cleaner according to an embodiment of the present disclosure;

FIG. 5 is a schematic diagram of an apparatus for acquiring water consumption of a robot vacuum cleaner according to another embodiment of the present disclosure; and

FIG. 6 is a schematic diagram of an electronic device according to an embodiment of the present disclosure.

### DETAILED DESCRIPTION

Embodiments of the present disclosure are described in detail below, examples of which are illustrated in the drawings. The same or similar elements are denoted by same reference numerals in different drawings unless indicated otherwise. The embodiments described herein with reference to drawings are explanatory, and used to generally understand the present disclosure. The embodiments shall not be construed to limit the present disclosure.

Method and apparatus for acquiring water consumption of a robot vacuum cleaner, an electronic device and a non-transitory computer readable storage medium according to embodiments of the present disclosure are described below with reference to the drawings.

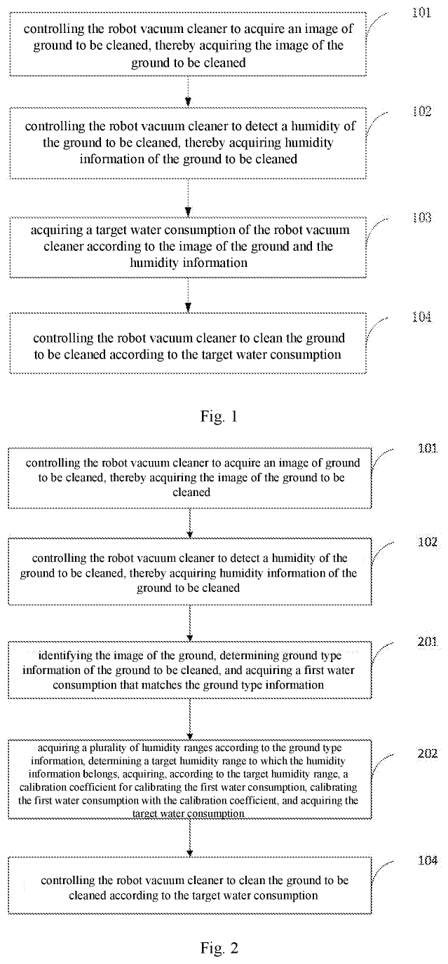

FIG. 1 is a flow chart of a method for acquiring water consumption of a robot vacuum cleaner according to an embodiment of the present disclosure. As shown in FIG. 1, the method includes following steps.

In block 101, the robot vacuum cleaner is controlled to acquire an image of ground to be cleaned, so as to acquire the image of the ground to be cleaned.

In order to realize the image acquiring function for the robot vacuum cleaner, a corresponding image acquiring device should be set on the robot vacuum cleaner. When the robot vacuum cleaner starts working, the image acquiring device is activated to collect images of ground. In one embodiment, the image acquiring device may be disposed under a body of the robot vacuum cleaner to collect the images of ground under the robot vacuum cleaner. In one embodiment, the image acquiring device may be disposed on a head of the robot vacuum cleaner to collect image information of ground in front of the robot vacuum cleaner in its forward direction, which is about to be cleaned.

In block 102, the robot vacuum cleaner is controlled to detect a humidity of the ground to be cleaned, so as to acquire humidity information of the ground to be cleaned.

In order to realize the humidity information collecting function for the robot vacuum cleaner, a corresponding humidity collecting device should be set on the robot vacuum cleaner. In one embodiment, the humidity collecting device should be disposed under the body of the robot vacuum cleaner. In order to ensure the accuracy of the humidity of the ground collected by the humidity collecting device, the humidity collecting device should be as close as possible to the ground. For a robot vacuum cleaner with a lower chassis, the humidity collecting device can be disposed inside the body, and the humidity information is collected through a through-hole at the bottom of the body. In this case, a relative small distance between the humidity collecting device and the ground can also be satisfied. For a robot vacuum cleaner with a higher chassis, the humidity collecting device is required to be a projection on the chassis of the robot vacuum cleaner.

In an actual application, the ground may be uneven. If the humidity collecting device is directly disposed on the chassis, the humidity collecting device has a great possibility to touch the ground during working, resulting in damage to the humidity collecting device, and thus the collection accuracy is affected. The humidity collecting device may even be stuck in somewhere, and thus the robot vacuum cleaner is hanging there and cannot move forward. In order to avoid above situations, in some embodiments of the present disclosure, the humidity collecting device may be disposed on or near a driving wheel at the bottom of the robot vacuum cleaner, where it is close to the ground, but will not touch the ground, thus ensuring the collection of humidity signals.

In block 103, a target water consumption of the robot vacuum cleaner is acquired according to the image of the ground and the humidity information.

In one embodiment, the image of the ground and the humidity information are input into a first trained machine learning model for learning, a recommending probability is acquired for every recommending water consumption corresponding to the ground to be cleaned, and the recommending water consumption with the highest recommending probability is selected as the target water consumption.

During the training of the first machine learning model, a plurality of recommending water consumptions is trained. After the image of the ground and the humidity information are input into the first trained machine learning model, the first machine learning model learns a recommending probability for each recommending water consumption. If a recommending probability for a recommending water consumption is closer to 1, it indicates that the robot vacuum cleaner will cause less damage to the ground with such a recommending water consumption, that is, the recommending water consumption is more suitable to the cleaning requirements of the ground. Otherwise, if a recommending probability for a recommending water consumption is closer to 0, it indicates that the robot vacuum cleaner will cause more damage to the ground with such a recommending water consumption, that is, the recommending water consumption is less suitable to the cleaning requirements of the ground. Moreover, for the recommending water consumption with a recommending probability of 0, the humidity of the robot vacuum cleaner with such a water consumption may cause a certain degree of damage to the ground. Therefore, after acquiring all the recommending probabilities for all the recommending water consumptions, the recommending water consumption with the highest recommending probability is selected as the target water consumption.

It should be noted that, in the embodiments of the present disclosure, the image of the ground and the humidity information are collected by the robot vacuum cleaner, and the processes of analyzing the collected data and acquiring the water consumption for the cleaning process may be performed by a cloud server, or may be performed by the robot vacuum cleaner locally. When these processes are executed locally, the first machine learning model that has been trained is pre-stored in the robot vacuum cleaner, and the collected image of the ground and the humidity information can be input into the first machine learning model to acquire the target water consumption.

When these processes are executed by the cloud server, the collected image of the ground and the humidity information are sent from the robot vacuum cleaner to the cloud server through a wireless network. The cloud server can acquire the image of the ground and the humidity information, and then combine the first machine learning model in the cloud server to acquire the corresponding target water consumption.

In general, in order to reduce the energy consumption and cost of the robot vacuum cleaner, the cloud server is often used to perform the process of acquiring the target water consumption. However, in practice, when the wireless network signal between the robot vacuum cleaner and the cloud server is unstable or the robot vacuum cleaner is not in the coverage of the wireless network, the robot vacuum cleaner cannot transmit the collected ground image and humidity information through the wireless network to the cloud server. In this case, the robot vacuum cleaner can choose to analyze the data locally and acquire the corresponding target water consumption.

In block 104, the robot vacuum cleaner is controlled to clean the ground to be cleaned according to the target water consumption.

Further, after the corresponding target water consumption is acquired, if the water consumption is acquired locally by the robot vacuum cleaner, it can be directly applied to the robot vacuum cleaner to clean the ground to be cleaned according to the target water consumption. If the target water is acquired by the cloud server, it can be sent from the cloud server back to the robot vacuum cleaner through the wireless network. The robot vacuum cleaner receives the target water consumption and cleans the ground to be cleaned accordingly.

With the method for acquiring water consumption of the robot vacuum cleaner provided in embodiments of the present disclosure, a current situation of a target to be cleaned may be detected by intelligent means, and an optimal water quantity parameter can be recommended according to the current situation, so as to realize the control of the water consumption adapted to the target to be cleaned and achieve an optimal water discharge effect, thus improving intelligence level and cleaning efficiency of the robot vacuum cleaner.

FIG. 2 is a flow chart of a method for acquiring water consumption of a robot vacuum cleaner according to another embodiment of the present disclosure. As shown in FIG. 2, the present disclosure provides in embodiments a process of acquiring the target water consumption of the robot vacuum cleaner according to the image of the ground and the humidity information, which includes following steps.

In block 201, the image of the ground is identified, ground type information of the ground to be cleaned is determined, and a first water consumption that matches the ground type information is acquired.

In actual practice, the robot vacuum cleaner may face various ground conditions. For example, most of the home floor is made of ceramic tiles. The water consumption for cleaning this kind of ground is in a large range, and the ground will not be damaged by excessive water consumption. At the same time, for some families, the ground is made of wood. This kind of ground requires a less water consumption for the robot vacuum cleaner during cleaning, otherwise it will easily cause softening, bulging and deformation of the ground. When the home ground is covered by a carpet, the water consumption of the robot vacuum cleaner should be 0, that is, the robot vacuum cleaner can only activate the sweeping function and cannot activate the mopping function at this time. In addition to the above examples, there are some other restrictions on the water output of the robot vacuum cleaner, and thus the ground type of the current cleaning ground should be determined by the robot vacuum cleaner before the water consumption is matched.

As a possible implementation manner, for example, the target water consumption is acquired by the cloud server in this embodiment. Firstly, the image of the ground collected by the image acquiring device is uploaded to the cloud server, and the cloud server responds to the robot vacuum cleaner and inputs the transmitted image of the ground into a trained ground type identifying model for learning, and acquires information of a specific ground type through analysis. Then, the first target water consumption that is matched with the learned ground type information is acquired by querying a list of a relationship between ground type information and water consumption stored in the cloud server according to the learned ground type information.

In block 202, a plurality of humidity ranges are acquired according to the ground type information, a target humidity range to which the humidity information belongs is determined, a calibration coefficient for calibrating the first water consumption is acquired according to the target humidity range, the first water consumption is calibrated with the calibration coefficient, and the target water consumption is acquired.

Further, the cloud server further stores a list of a relationship between ground type and humidity range of such the ground, and a plurality of possible humidity ranges of the ground may be acquired according to the ground type. While the above image of the ground is uploaded to the cloud server, the humidity information is also sent to the cloud server. The cloud server determines that the humidity information of the current ground is within a certain humidity range acquired as above, and the target range corresponds to the calibration coefficient for calibrating the water consumption. The first target water consumption acquired according to the ground type is calibrated with the calibration coefficient, and thus the target water consumption is acquired.

In one embodiment, a plurality of humidity ranges may be allowable for the same ground type, and the humidity ranges are continuous in humidity units (for example, water vapor pressure). Normally, the ground will not be damaged in these humidity ranges, and thus these humidity ranges can be recognized as safe humidity range of the ground. With respect to these humidity ranges, when humidity data collected from the ground is close to an upper limit of these humidity ranges, the humidity of the ground is high, and is more likely to exceed the safe humidity range and cause damage to the ground. At this time, a large calibration coefficient is required for calibrating the water output for the target, i.e., increasing restrictions on the water output, so as to reduce the water output, thus preventing the ground from being damaged by the excessive water. According to the same principle, when humidity data collected from the ground is close to a lower limit of these humidity ranges (it is found through analysis of actual situations that the ground may be damaged when the humidity of the ground is very low, for example, a concrete floor cracks when the humidity is too low), a relative low humidity is selected for calibrating the water output for the target, i.e., decreasing restrictions on the water output, where a large water consumption is used to clean the ground more completely. Moreover, the adjacent humidity can adopt a same calibration coefficient as long as the humidity does not exceed the above humidity range after the calibration, that is, the above-mentioned safe humidity range is divided into different continuous regions according to different calibration coefficients, and each region has the same calibration coefficient, which is beneficial to the storage and the query in the cloud server.

With the method for acquiring water consumption of the robot vacuum cleaner provided in embodiments of the present disclosure, by uploading the ground type and the humidity information to the cloud server for machine learning to check the ground type and the humidity information, where an optimal water quantity parameter can be recommended, so as to realize the control of the water consumption adapted to the target to be cleaned and achieve an optimal water discharge effect, thus improving intelligence level and cleaning efficiency of the robot vacuum cleaner.

In an embodiment of the present disclosure, after the target water consumption is acquired as described above, the target water consumption may be further optimized by combining information of geographic location, weather condition, seasonal characteristics and humidity. In one embodiment, in rainy days, the air humidity is high and the water on the ground is difficult to evaporate, where it is more likely to cause the accumulation of water, so as to exceed a safe range and cause damage to the ground when compared with other conditions. Therefore, the target water consumption should be reduced in rainy days. While, in some hot areas, the ambient temperature is high, the air humidity is high, the water on the ground is also difficult to evaporate, and thus the target water consumption should also be reduced in these areas.

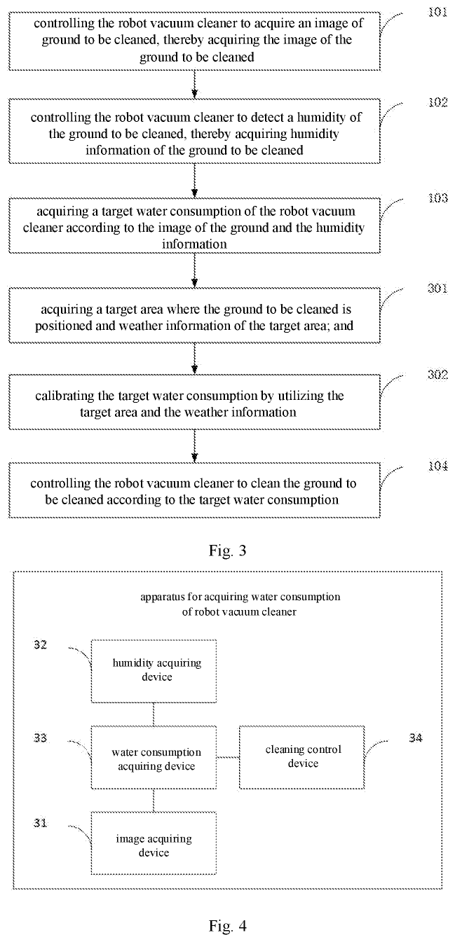

FIG. 3 is a flow chart of a method for acquiring water consumption of a robot vacuum cleaner according to still another embodiment of the present disclosure. As shown in FIG. 3, the method includes following steps.

In block 301, a target area, where the ground to be cleaned is positioned, and weather information of the target area are acquired.

In an embodiment of the present disclosure, the robot vacuum cleaner may be connected to a weather forecasting server through network, and then receive current weather information from the server through the network. Moreover, a positioning device is disposed on the robot vacuum cleaner, and positioning information is acquired by the positioning device. Further, according to the positioning information, the target area (geographical location) where the ground to be cleaned is positioned can be determined.

In block 302, the target water consumption is calibrated by utilizing the target area and the weather information.

As a possible implementation manner, after the target area and the weather information are acquired, the image of the ground, the humidity information, the target area and the weather information are input into a second trained machine learning model for learning, a recommending probability is acquired for every recommending water consumption corresponding to the ground to be cleaned, and the recommending water consumption with the highest recommending probability is selected as the target water consumption. Since more factors affecting the water consumption, such as the geographical location and the weather condition, have been considered during the machine learning, the target water consumption may be calibrated accordingly, where the finally acquired water consumption is more suitable to the actual requirements of a current application scenario of the robot vacuum cleaner.

It should be noted that, in the embodiments of the present disclosure, the image of the ground, the humidity information, the target area and the weather information are collected by the robot vacuum cleaner, and the processes of analyzing the collected information and acquiring the water consumption during the cleaning process may be performed by the cloud server or locally by the sweeping robot. For the process performed by the cloud server or may be performed by the robot vacuum cleaner locally. These processes performed by the cloud server or the local terminal may refer to the description of related contents in the foregoing embodiments, which are not described in detail here again.

As another possible implementation manner, the cloud server stores a relationship list showing different weather information and corresponding calibration coefficients thereof. At the same time, calibration coefficients corresponding to different target areas are also stored. After the two kinds of calibration coefficients are searched and determined, the target water consumption, which is acquired by analyzing the image of the ground and the humidity information, is calibrated with the calibration coefficient for the weather information, so as to acquire a first target water consumption. Then, the first target water consumption is calibrated with the calibration coefficient for the target area, so as to acquire a second target water consumption. The second target water consumption as acquired finally is used as a final target water consumption of the robot vacuum cleaner. The cloud server transmits the selected target water consumption to the robot vacuum cleaner, and controls the robot vacuum cleaner to clean the ground according to the target water consumption.

In this embodiment of the present disclosure, by creating analyzing and learning the target area and the weather information of the robot vacuum cleaner, the target water consumption is further calibrated, thus further improving the accuracy of selecting the water consumption for the robot vacuum cleaner, and efficiently avoiding the possible damage caused by wrongly selected water consumption.

In order to achieve the above embodiments, the present disclosure also provides an apparatus for acquiring water consumption of a robot vacuum cleaner. In one embodiment, the apparatus is arranged on the robot vacuum cleaner to recommend an optimal water quantity parameter, so as to realize the control of the water consumption adapted to the target to be cleaned and achieve an optimal water discharge effect.

FIG. 4 is a schematic diagram of an apparatus for acquiring water consumption of a robot vacuum cleaner according to an embodiment of the present disclosure. As shown in FIG. 4, the apparatus In one embodiment includes:

an image acquiring device 31 configured to control the robot vacuum cleaner to acquire an image of ground to be cleaned, so as to acquire the image of the ground to be cleaned;

a humidity acquiring device 32 configured to control the robot vacuum cleaner to detect a humidity of the ground to be cleaned, so as to acquire humidity information of the ground to be cleaned;

a water consumption acquiring device 33 configured to acquire a target water consumption of the robot vacuum cleaner according to the image of the ground and the humidity information; and

a cleaning control device 34 configured to control the robot vacuum cleaner to clean the ground to be cleaned according to the target water consumption.

Further, the water consumption acquiring device 33 is In one embodiment configured to:

identify the image of the ground, determine ground type information of the ground to be cleaned, and acquire a first water consumption that matches the ground type information; and

acquire a plurality of humidity ranges according to the ground type information, determine a target humidity range to which the humidity information belongs, acquire, according to the target humidity range, a calibration coefficient for calibrating the first water consumption, calibrate the first water consumption with the calibration coefficient, and acquire the target water consumption.

Further, the water consumption acquiring device 33 is In one embodiment configured to:

input the image of the ground and the humidity information into a first trained machine learning model for learning, acquire a recommending probability for every recommending water consumption corresponding to the ground to be cleaned, and select the recommending water consumption with the highest recommending probability as the target water consumption.

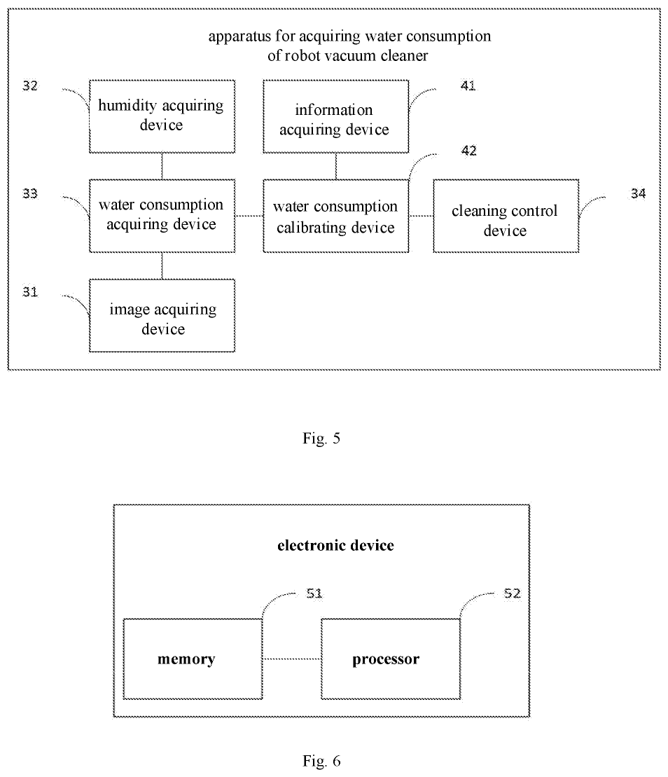

FIG. 5 is a schematic diagram of an apparatus for acquiring water consumption of a robot vacuum cleaner according to another embodiment of the present disclosure. As shown in FIG. 5, the apparatus further includes:

an information acquiring device 41 configured to acquire a target area where the ground to be cleaned is positioned and weather information of the target area; and

a water consumption calibrating device 42 configured to calibrate the target water consumption by utilizing the target area and the weather information.

Further, the water consumption calibrating device 42 is In one embodiment configured to:

acquire a calibration coefficient for the weather information, and calibrate the target water consumption with the calibration coefficient for the weather information, so as to acquire a first target water consumption;

acquire a calibration coefficient for the target area, and calibrate the first target water consumption with the calibration coefficient for the target area, so as to acquire a second target water consumption; and

determine the second target water consumption as a final target water consumption of the robot vacuum cleaner.

Further, after acquiring the target area and the weather information, the water consumption acquiring device 33 is In one embodiment configured to:

input the image of the ground, the humidity information, the target area and the weather information into a second trained machine learning model for learning, acquire a recommending probability for every recommending water consumption corresponding to the ground to be cleaned, and select the recommending water consumption with the highest recommending probability as the target water consumption.

Further, when the apparatus for acquiring water consumption of the robot vacuum cleaner is applied in a cloud server, the cleaning control device 34 is further configured to:

send the target water consumption back to the robot vacuum cleaner after the target water consumption is acquired.

In order to achieve the above embodiments, the present disclosure also provides an electronic device. FIG. 6 is a schematic diagram of an electronic device according to an embodiment of the present disclosure. As shown in FIG. 6, the electronic device includes a memory 61 and a processor 62.

In one embodiment, the processor 62 reads an executable program code stored in the memory 61 to execute a program corresponding to the executable program code, so as to perform a method for acquiring water consumption of a robot vacuum cleaner provided in the above embodiments.

In order to achieve the above embodiments, the present disclosure also provides a non-transitory computer readable storage medium having stored therein a computer program that, when executed by a processor, causes the processor to perform a method for acquiring water consumption of a robot vacuum cleaner provided in the above embodiments.

In the specification, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial” and “circumferential” should be construed to refer to the orientation as then described or as shown in the drawings under discussion. These relative terms are for convenience of description and do not require that the present disclosure be constructed or operated in a particular orientation, and thus shall not be construed to limit the present disclosure.

In addition, terms such as “first” and “second” are used herein for purposes of description and are not intended to indicate or imply relative importance or significance or to imply the number of indicated features. Thus, the feature defined with “first” and “second” may include one or more of this feature. In the description of the present disclosure, unless specified otherwise, “a plurality of” means two or more than two.

In the present disclosure, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications of two elements.

In the description, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed there between. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. Thus, the appearances of above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples described in the specification, as well as features of embodiments or examples.

1. A method for acquiring water consumption of a robot vacuum cleaner, comprising:
controlling the robot vacuum cleaner to acquire an image of ground to be cleaned, wherein the image of the ground to be cleaned is acquired;
controlling the robot vacuum cleaner to detect a humidity of the ground to be cleaned, wherein humidity information of the ground to be cleaned is acquired;
acquiring a target water consumption of the robot vacuum cleaner according to the image of the ground and the humidity information; and
controlling the robot vacuum cleaner to clean the ground to be cleaned according to the target water consumption.

2. The method according to claim 1, wherein acquiring a target water consumption of the robot vacuum cleaner according to the image of the ground and the humidity information comprises:
identifying the image of the ground, determining ground type information of the ground to be cleaned, and acquiring a first water consumption that matches the ground type information; and
acquiring a plurality of humidity ranges according to the ground type information, determining a target humidity range to which the humidity information belongs, acquiring, according to the target humidity range, a calibration coefficient for calibrating the first water consumption, calibrating the first water consumption with the calibration coefficient, and acquiring the target water consumption.

3. The method according to claim 1, wherein acquiring a target water consumption of the robot vacuum cleaner according to the image of the ground and the humidity information comprises:
inputting the image of the ground and the humidity information into a first trained machine learning model for learning, acquiring a recommending probability for every recommending water consumption corresponding to the ground to be cleaned, and selecting the recommending water consumption with the highest recommending probability as the target water consumption.

4. The method according to claim 1, further comprising:
acquiring a target area where the ground to be cleaned is positioned and weather information of the target area; and
calibrating the target water consumption by utilizing the target area and the weather information.

5. The method according to claim 4, wherein calibrating the target water consumption by utilizing the target area and the weather information comprises:
acquiring a calibration coefficient for the weather information, and calibrating the target water consumption with the calibration coefficient for the weather information, wherein a first target water consumption is acquired;
acquiring a calibration coefficient for the target area, and calibrating the first target water consumption with the calibration coefficient for the target area, wherein a second target water consumption is acquired; and
determining the second target water consumption as a final target water consumption of the robot vacuum cleaner.

6. The method according to claim 4, wherein acquiring a target water consumption of the robot vacuum cleaner according to the image of the ground and the humidity information comprises:
after acquiring the target area and the weather information, inputting the image of the ground, the humidity information, the target area and the weather information into a second trained machine learning model for learning, acquiring a recommending probability for every recommending water consumption corresponding to the ground to be cleaned, and selecting the recommending water consumption with the highest recommending probability as the target water consumption.

7. The method according to claim 4, wherein the method is executed by a cloud server, and the method further comprises:
sending the target water consumption back to the robot vacuum cleaner after the target water consumption is acquired.

8. An apparatus for acquiring water consumption of a robot vacuum cleaner, comprising:
an image acquiring device configured to control the robot vacuum cleaner to acquire an image of ground to be cleaned, so as to acquire the image of the ground to be cleaned;
a humidity acquiring device configured to control the robot vacuum cleaner to detect a humidity of the ground to be cleaned, so as to acquire humidity information of the ground to be cleaned;
a water consumption acquiring device configured to acquire a target water consumption of the robot vacuum cleaner according to the image of the ground and the humidity information; and
a cleaning control device configured to control the robot vacuum cleaner to clean the ground to be cleaned according to the target water consumption.

9. The apparatus according to claim 8, wherein the water consumption acquiring device is configured to:
identify the image of the ground, determine ground type information of the ground to be cleaned, and acquire a first water consumption that matches the ground type information; and
acquire a plurality of humidity ranges according to the ground type information, determine a target humidity range to which the humidity information belongs, acquire, according to the target humidity range, a calibration coefficient for calibrating the first water consumption, calibrate the first water consumption with the calibration coefficient, and acquire the target water consumption.

10. The apparatus according to claim 8, wherein the water consumption acquiring device is configured to:
input the image of the ground and the humidity information into a first trained machine learning model for learning, acquire a recommending probability for every recommending water consumption corresponding to the ground to be cleaned, and select the recommending water consumption with the highest recommending probability as the target water consumption.

11. The apparatus according to claim 8, further comprising:
an information acquiring device configured to acquire a target area where the ground to be cleaned is positioned and weather information of the target area; and
a water consumption calibrating device configured to calibrate the target water consumption by utilizing the target area and the weather information.

12. The apparatus according to claim 11, wherein the water consumption calibrating device is configured to:
acquire a calibration coefficient for the weather information, and calibrate the target water consumption with the calibration coefficient for the weather information, so as to acquire a first target water consumption;
acquire a calibration coefficient for the target area, and calibrate the first target water consumption with the calibration coefficient for the target area, so as to acquire a second target water consumption; and
determine the second target water consumption as a final target water consumption of the robot vacuum cleaner.

13. The apparatus according to claim 11, wherein after acquiring the target area and the weather information, the water consumption acquiring device is configured to:
input the image of the ground, the humidity information, the target area and the weather information into a second trained machine learning model for learning, acquire a recommending probability for every recommending water consumption corresponding to the ground to be cleaned, and select the recommending water consumption with the highest recommending probability as the target water consumption.

14. The apparatus according to claim 11, wherein the apparatus is applied in a cloud server;
the cleaning control device is further configured to send the target water consumption back to the robot vacuum cleaner after the target water consumption is acquired.

15. (canceled)

16. A non-transitory computer readable storage medium having stored therein a computer program for acquiring water consumption of a robot vacuum cleaner that, when executed by a processor, causes the processor to:
control the robot vacuum cleaner to acquire an image of ground to be cleaned, wherein the image of the ground to be cleaned is acquired;
control the robot vacuum cleaner to detect a humidity of the ground to be cleaned, wherein humidity information of the ground to be cleaned is acquired;
acquire a target water consumption of the robot vacuum cleaner according to the image of the ground and the humidity information; and
control the robot vacuum cleaner to clean the ground to be cleaned according to the target water consumption.

17. The non-transitory computer readable storage medium according to claim 16, wherein acquiring a target water consumption of the robot vacuum cleaner according to the image of the ground and the humidity information further causes the processor to:
identify the image of the ground, determining ground type information of the ground to be cleaned, and acquiring a first water consumption that matches the ground type information; and
acquire a plurality of humidity ranges according to the ground type information, determining a target humidity range to which the humidity information belongs, acquiring, according to the target humidity range, a calibration coefficient for calibrating the first water consumption, calibrating the first water consumption with the calibration coefficient, and acquiring the target water consumption.

18. The non-transitory computer readable storage medium according to claim 16, wherein acquiring a target water consumption of the robot vacuum cleaner according to the image of the ground and the humidity information further causes the processor to:
input the image of the ground and the humidity information into a first trained machine learning model for learning, acquiring a recommending probability for every recommending water consumption corresponding to the ground to be cleaned, and selecting the recommending water consumption with the highest recommending probability as the target water consumption.

19. The non-transitory computer readable storage medium according to claim 16, wherein the computer program code further causes the processor to:
acquire a target area where the ground to be cleaned is positioned and weather information of the target area; and
calibrate the target water consumption by utilizing the target area and the weather information.

20. The non-transitory computer readable storage medium according to claim 19, wherein calibrating the target water consumption by utilizing the target area and the weather information causes the processor to:
acquire a calibration coefficient for the weather information, and calibrating the target water consumption with the calibration coefficient for the weather information, wherein a first target water consumption is acquired;
acquire a calibration coefficient for the target area, and calibrating the first target water consumption with the calibration coefficient for the target area, wherein a second target water consumption is acquired; and
determine the second target water consumption as a final target water consumption of the robot vacuum cleaner.

21. The non-transitory computer readable storage medium according to claim 19, wherein acquiring a target water consumption of the robot vacuum cleaner according to the image of the ground and the humidity information causes the processor to:
after acquiring the target area and the weather information, input the image of the ground, the humidity information, the target area and the weather information into a second trained machine learning model for learning, acquiring a recommending probability for every recommending water consumption corresponding to the ground to be cleaned, and selecting the recommending water consumption with the highest recommending probability as the target water consumption.
